(19) United States
(12) Patent Application Publication
(10) Pub. No.: US 2004/0263862 A1
(43) Pub. Date: Dec. 30, 2004

(54) Detecting peripheral points of reflected radiation beam spots for topographically mapping a surface

(76) Inventors: Alfonso Benjamin Amparan, Fort Collins, CO (US); David Lee Gines, Fort Collins, CO (US); Ronald Kerschner, Loveland, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/603,109

(22) Filed: Jun. 24, 2003

(51) Int. Cl. G01B 11/24

(52) U.S. Cl. 356/601

(57) ABSTRACT

Systems and methods of detecting peripheral points of reflected radiation beam spots for topographically mapping a surface are described. In one aspect, a radiation beam is directed toward a target location on the surface. An image of a beam spot is captured at a location in an image plane intersecting at least a portion of the radiation beam reflected from the target location on the surface. At least one image plane coordinate for a peripheral point of the beam spot image is identified. A relative height value is assigned to the target location based on a mapping of the at least one image plane coordinate identified for the peripheral beam spot point to the relative height value.

### BACKGROUND

Many different approaches have been developed for topographically mapping a surface, including laser triangulation based techniques, focus sensing methods, interferometric methods, and time-of-flight laser rangefinder based techniques. In laser triangulation topographical mapping, a light beam is directed at a surface and a camera or other imaging device captures an image of light reflected from the surface. The heights of features on the surface are translated into lateral positions in the captured image. In focus sensing systems, the distance to a point on an object is determined by focusing an imaging device onto the point. In an interferometer based approach, an interferometer measures the difference in phase between a variable distance measurement signal and a fixed distance reference signal. An interferometer is a relative distance measurement system in which the measurement and fixed signals paths cannot be broken when measuring between two points. A time-of-flight rangefinder includes a transmitter, a scanning mirror, and a receiver. The transmitter directs a reference signal to the receiver and simultaneously directs a measurement signal to a location on an object of interest. The difference in the times when the receiver receives the reference signal and the measurement signal is used to compute the distance to the object.

Topological surface mapping systems and methods are used in a variety of different applications. In one exemplary application, topological surface mapping techniques are used in systems for inspecting solder connections and electronic devices on a laminated printed circuit board. Many of such inspection systems use penetrating radiation (e.g., X-rays) to form images that capture the internal structure of the electronic devices and connections. In a laminography system that views a fixed object and has an imaging area that is smaller than the object being inspected, it is necessary to move different regions of the object within the imaging area. In these systems, the object typically is supported on a mechanical handling system, such as an X, Y, Z positioning table. The table is moved to bring the desired regions of the object into the imaging area. Movement in the X and Y directions locates the region to be examined, and movement in the Z direction selects the cross-sectional image focal plane within the object.

In many laminography systems, an X-ray source and an X-ray detector are separated in the Z direction by a fixed distance and the cross-sectional image focal plane is located at a predetermined specific position in the Z direction between the X-ray source and the X-ray detector. In these systems, the positions of the cross-sectional image focal plane and the desired plane containing a desired feature of the test object to be imaged should coincide at the same Z direction position. One common technique for aligning the desired feature of the test object with the cross-sectional image focal plane involves physically measuring the Z direction position of the selected feature. Based on this measurement, the test object is positioned in the Z direction such that the selected feature coincides with the Z direction position of the cross-sectional image focal plane. Any of a variety of standard methods and instruments may be used to physically measure the Z direction position of the selected feature of the test object. Such systems typically are used to form a Z-map (or height map) of the surface of the test object. The Z-map typically consists of an (X, Y) array of the Z-values of the surface of the test object. The (X, Y) locations are points on a plane of the test object that is substantially parallel to the cross-sectional image focal plane.

### SUMMARY

The invention features systems and methods of detecting peripheral points of reflected radiation beam spots for topographically mapping a surface. The invention enables the heights of features of a surface to be determined more accurately than other topographical mapping approaches that rely on non-peripheral beam spot points, at least with respect to topographical mapping of semitransparent surfaces.

In one aspect, the invention features a method of topographically mapping a surface. In accordance with this inventive method, a radiation beam is directed toward a target location on the surface. An image of a beam spot is captured at a location in an image plane intersecting at least a portion of the radiation beam reflected from the target location on the surface. At least one image plane coordinate for a peripheral point of the beam spot image is identified. A relative height value is assigned to the target location based on a mapping of the at least one image plane coordinate identified for the peripheral beam spot point to the relative height value.

The invention also features a system for implementing the above-described method of topographically mapping a surface.

In another aspect, the invention features a computer program for topographically mapping a surface. The computer program resides on a computer-readable medium and comprises computer-readable instructions for causing a computer to identify at least one image plane coordinate for a peripheral point of a beam spot image captured at an image plane intersecting at least a portion of radiation beam reflected from a target location on the surface. The computer program also comprises computer-readable instructions for causing a computer to assign a relative height value to the target location based on a mapping of the at least one image plane coordinate identified for the peripheral beam spot point to the relative height value.

Other features and advantages of the invention will become apparent from the following description, including the drawings and the claims.

### DESCRIPTION OF DRAWINGS

FIG. 1 is a diagrammatic side view of a system for topographically mapping a surface.

FIG. 2 is a flow diagram of a method of topographically mapping a surface.

FIG. 3A is a diagrammatic view of an image of a beam spot captured at an image plane intersecting a radiation beam reflected off of a reflective surface.

FIG. 3B is a graph of light intensity plotted as a function of position along a line in a region of the image plane containing the beam spot image of FIG. 3A.

FIG. 4 is a diagrammatic side view of the system of FIG. 1 directing a radiation beam toward a semi-transparent surface.

FIG. 5A is a diagrammatic view of an image of a beam spot captured at an image plane intersecting a radiation beam reflected off of the semi-transparent surface of FIG. 4.

FIG. 5B is a graph of light intensity plotted as a function of position along a line in a region of the image plane containing the beam spot image of FIG. 5A.

FIGS. 6A, 6B, and 6C are perspective views of triangular mesh laser surface maps superimposed on respective circuit boards.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

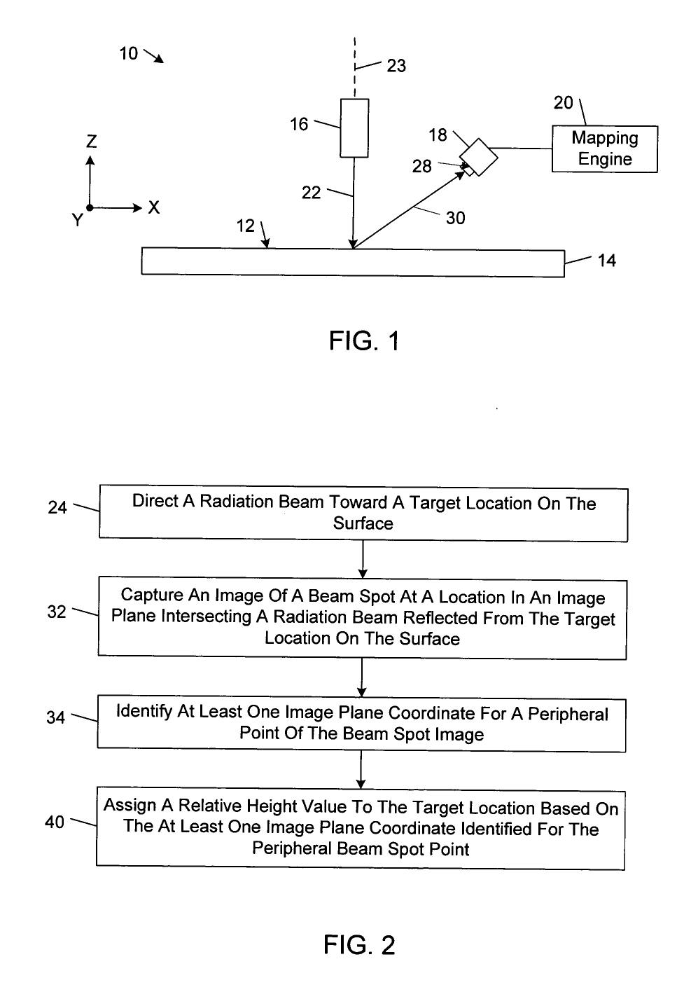

FIG. 1 shows an embodiment of a system 10 for topographically mapping a surface 12 of an object 14. Topographical surface mapping system 10 includes a radiation source 16, an imager 18, and a mapping engine 20. Object 14 may be any object of interest with a surface 12 of which a topographical map is desired. Radiation source 16 may be any source of a narrow beam of radiation. In one exemplary implementation, radiation source 16 is a laser that generates a laser beam in the near infrared wavelength range (e.g., 780-830 nanometers). Imager 18 may be any suitable imaging device or system. Exemplary imaging devices include computer-controllable digital cameras (e.g., a Kodak DCS760 camera), USB video cameras, and Firewire/1394 cameras. USB video cameras or “webcams,” such as the Intel PC Pro, generally capture images 30 fps (frames per second) at a resolution of 320 pixels by 240 pixels. Mapping engine 20 may be implemented in any computing or processing environment, including in digital electronic circuitry or in computer hardware, firmware, or software. In some implementations, mapping engine 20 is implemented as one or more software modules that are executable on a computer (or workstation).

Referring to FIGS. 1, 2, 3A and 3B, topographical mapping system 10 may be operated to topographically map surface 12 of object 14 as follows. In the following description, the topographical map corresponding to the profile of surface 12 is described in an orthogonal (X, Y, Z) Cartesian coordinate system, where the X and Y directions define a plane that is substantially parallel to surface 12 and the Z direction is substantially normal to surface 12.

Radiation source 16 directs a radiation beam 22 toward a target location on surface 12 (step 24). In the illustrated embodiment, radiation beam 22 is directed along a beam axis 23 that is substantially parallel to the Z direction. Imager 18 captures an image of a beam spot 26 at a location in an image plane 28 that intersects at least of portion 30 of the radiation beam that is reflected from the target location on surface 12 (step 32). In the illustrated embodiment, the image plane 28 is described with respect to an orthogonal (X′, Y′) Cartesian coordinate system, where the Y′ direction is substantially parallel to a projection of the beam axis 23 onto the image plane 28 and the X′ direction is substantially parallel to the X-Y plane.

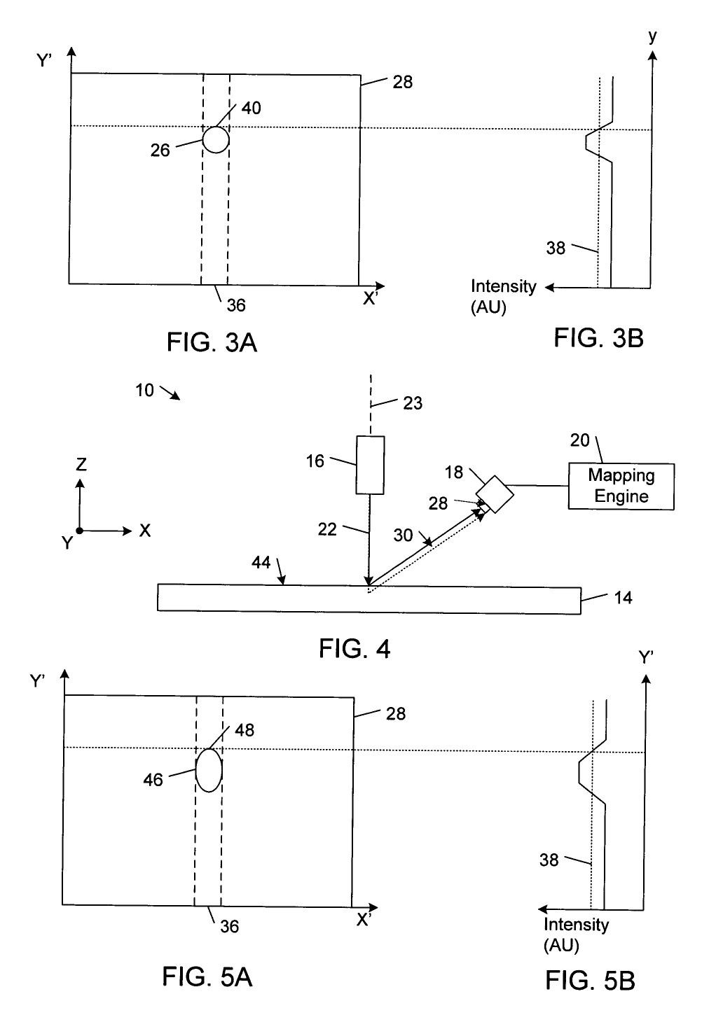

Mapping engine 20 identifies at least one coordinate in the image plane 28 for a peripheral point of the beam spot image 26 (step 34). In some implementations, mapping engine 20 searches for beam spot image 26 in a relatively narrow rectangular region 36 to avoid errors that otherwise might be caused by spurious reflections and other artifacts. Region 36 corresponds to a linear path along which the beam spot image 26 traverses the image plane 28 for different relative heights (or Z direction positions) of the surface 12. In these implementations, the rectangular area of image plane 28 corresponding to region 36 is determined during a pre-measurement calibration stage in which a series of objects having known relative heights are positioned in the target location. The resulting set of reflected beam portions 30 are captured as beam spot images along the relatively narrow rectangular region 36. In some embodiments, mapping engine 20 identifies the Y′ direction coordinates of peripheral beam spot points that substantially correspond to the highest respective points of reflection from the target location of surface 12 (e.g., peripheral point 40 near the top of beam spot image 26 in FIG. 3A). The set of Y′ direction coordinates is stored in a lookup table that maps relative heights (or Z direction positions) to Y′ direction coordinates. The lookup table is used during the measurement stage to topographically map surface 12.

Referring to FIG. 3B, mapping engine 20 identifies the calibration and measurement Y′ direction coordinates by applying a threshold to pixel values in the rectangular region 36 of image plane 28. In some embodiments, mapping engine 20 applies a normalized grayscale threshold to the pixel values in region 36. Mapping engine 20 computes the normalized threshold based on the high and low grayscale pixel values within region 36. In one exemplary implementation, mapping engine 20 computes a normalized grayscale threshold 38 that corresponds to a pixel value that is midway (e.g., 50%) between the high and low pixel values within region 36. Mapping engine 20 applies threshold 38 to identify the peripheral point 40 of beam spot image 26 that substantially corresponds to the highest point of reflection from the target location on surface 12.

In some embodiments, mapping engine 20 identifies both X′ and Y′ direction coordinates of peripheral points for each beam spot image in order to identify the appropriate upper peripheral beam spot points. For example, mapping engine 20 may store in the lookup table the Y′ direction coordinates corresponding to the upper peripheral beam spot image points that are substantially centered in the region 36 in the X′ direction and that have respective pixel values that are closest to the pixel value threshold.

Referring back to FIG. 1, after the Y′ direction coordinate of the peripheral point 40 of the beam spot image 26 is identified (step 34), mapping engine 20 assigns a relative height value to the target location based on the identified Y′ direction coordinate using the calibrated lookup table (step 42).

In the exemplary surface profile measurement shown in FIGS. 3A and 3B, the surface 12 is assumed to be highly reflective of the radiation beam 12. In this example, imager 18 captures the beam spot at the image plane 28 as a substantially circular beam spot image 26.

Referring to FIGS. 4, 5A and 5B, in some instances, topographical mapping system 10 is used to map a semitransparent surface 44. For example, some printed circuit boards (e.g., printed circuit boards made from FR4-type or G10-type fiberglass) are semitransparent with respective to laser beams in the near infrared wavelength range. In these instances, the incident radiation beam 26 penetrates surface 44 and produces an asymmetric reflected beam portion 30 that is diffused (or spread out) in the Z direction. Imager 18 captures the resulting beam spot at the image plane 28 as an elliptical beam spot image 46 that is elongated in the Y′ direction. In spite of such beam spot spreading, mapping engine 20 still is able to accurately assign a relative height value to the target location because the Y′ direction coordinate of the point 48 identified using the above-described method substantially corresponds to the highest point of reflection from the target location on surface 12. In this way, the above-described topographical surface mapping approach is substantially more robust than other approaches that determine relative height values based on some non-peripheral (e.g., average or median) location within beam spot image 46 in image plane 28, at least with respect to topographical surface mapping of semitransparent substrates.

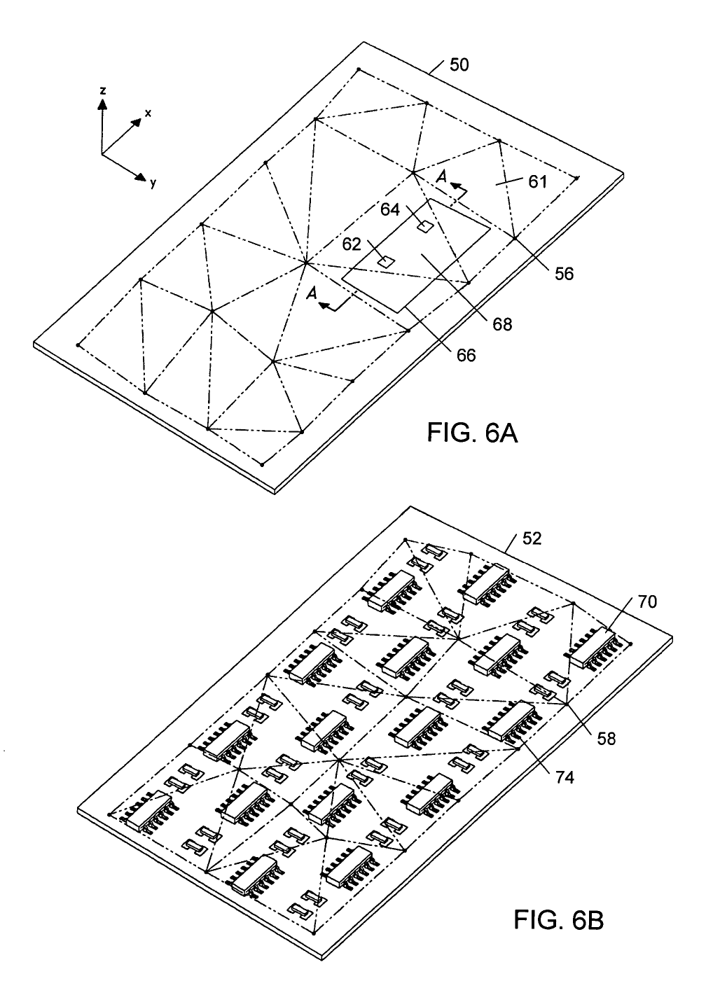

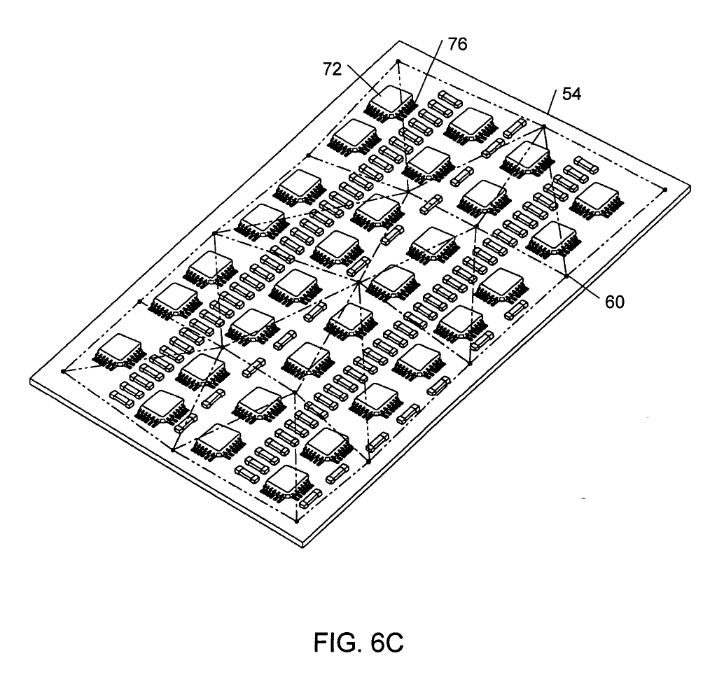

Referring to FIGS. 6A, 6B, and 6C, in some embodiments, topographical surface mapping system 10 is incorporated into a circuit board inspection system to create Z-maps of the surface of circuit boards 50, 52, 54 based on a plurality of laser surface map points 56, 58, 60. Referring to FIG. 6A, the laser surface map points 56 are interconnected to form a series of individual surface map triangles 61 that together form a triangular mesh representing a “backbone” for the board 50. For clarity of illustrating the surface map triangles 61 and the triangular mesh, the circuit board 50 shows only two solder pads 62, 64 that are located within a board view 66, which has a center location 68. Other electrical components that typically would be mounted to the board 66 are not shown. FIGS. 6B and 6C illustrate laser map triangular meshes that are superimposed on circuit boards 52 and 54 that have a variety of electronic components 70, 72 attached to the circuit boards 52, 54 by solder connections 74, 76.

In operation, the topographical surface mapping system 10 determines a height (or relative Z direction position) for each of the laser surface map points 56, 58, 60 on the surfaces of the boards 50, 52, 54. The locations of the laser surface map points 56, 58, 60 on the surfaces of the circuit boards 50, 52, 54 are predetermined by the specific design and layout of components 62, 64, 70, 72 74, 76 on the boards 50, 52, 54 and the inspection criteria for specific regions of the boards. The laser map points 56, 58, 60 typically are located near the solder joints 62, 64, 74, 76 being inspected. In addition, the size of the each surface map triangle of the mesh is determined by the availability of laser map points 56, 58, 60 that do not interfere with components 62, 64, 70, 72 74, 76 mounted to boards 50, 52, 54 and the desired accuracy of the Z-map for specific regions of the boards. For example, specific regions of the boards 50, 52, 54 may have characteristics which require smaller surface map triangles to accurately reflect the Z elevation of the solder joints 62, 64, 74, 76 located within those regions.

Other embodiments are within the scope of the claims.

For example, in other embodiments, non-grayscale-thresholding techniques are used to identify the Y′ direction locations of the peripheral beam spot points.

What is claimed is:

1. A method of topographically mapping a surface, comprising:
directing a radiation beam toward a target location on the surface;
capturing an image of a beam spot at a location in an image plane intersecting at least a portion of the radiation beam reflected from the target location on the surface;
identifying at least one image plane coordinate for a peripheral point of the beam spot image; and
assigning a relative height value to the target location based on a mapping of the at least one image plane coordinate identified for the peripheral beam spot point to the relative height value.

2. The method of claim 1, wherein the radiation beam is directed along a beam axis and an image plane coordinate is identified with respect to a first direction substantially parallel to a projection of the beam axis onto the image plane.

3. The method of claim 2, wherein the peripheral point is located at a peripheral area of the beam spot closer to the beam axis than other comparable peripheral areas of the beam spot.

4. The method of claim 1, wherein identifying the at least one image plane coordinate comprises applying a threshold to pixel values of the beam spot image.

5. The method of claim 4, wherein a normalized grayscale threshold is applied to the pixel values of the beam spot image.

6. The method of claim 1, wherein assigning a relative height value to the target location comprises mapping the at least one image plane coordinate to a predetermined relative height value.

7. The method of claim 6, wherein the at least one image plane coordinate is mapped to the predetermined relative height value based on a lookup table.

8. The method of claim 1, wherein the surface forms a boundary of a substrate and is semitransparent with respect to the radiation beam.

9. The method of claim 8, wherein the substrate is a printed circuit board.

10. The method of claim 9, further comprising repeating the steps of directing, capturing, identifying, and assigning for a plurality of target location on the surface of the printed circuit board arranged in a prescribed triangular mesh pattern.

11. A system for topographically mapping a surface, comprising:
a radiation source oriented to direct a radiation beam toward a target location on the surface;
an imager oriented to capture an image of a beam spot at a location in an image plane intersecting at least a portion of the radiation beam reflected from the target location on the surface;
a mapping engine operable to identify at least one image plane coordinate for a peripheral point of the beam spot image, and to assign a relative height value to the target location based on a mapping of the at least one image plane coordinate identified for the peripheral beam spot point to the relative height value.

12. The system of claim 11, wherein the radiation source is oriented to direct the radiation beam along a beam axis, and the mapping engine is operable to identify animage plane coordinate with respect to a first direction substantially parallel to a projection of the beam axis onto the image plane.

13. The system of claim 12, wherein the peripheral beam spot point is located at a peripheral area of the beam spot closer to the beam axis than other comparable peripheral areas of the beam spot.

14. The system of claim 11, wherein the mapping engine is operable to identify the image plane coordinates by applying a threshold to pixel values of the beam spot image.

15. The system of claim 14, wherein the mapping engine is operable to apply a normalized grayscale threshold to the pixel values of the beam spot image.

16. The system of claim 11, wherein the mapping engine is operable to assign a relative height value to the target location by mapping the at least one image plane coordinate to a predetermined relative height value.

17. The system of claim 16, wherein the mapping engine is operable to map the at least one image plane coordinate to the predetermined relative height value based on a lookup table.

18. A computer program for topographically mapping a surface, the computer program residing on a computer-readable medium and comprising computer-readable instructions for causing a computer to:
identify at least one image plane coordinate for a peripheral point of a beam spot image captured at an image plane intersecting at least a portion of radiation beam reflected from a target location on the surface, and
assign a relative height value to the target location based on a mapping of the at least one image plane coordinate identified for the peripheral beam spot point to the relative height value.

19. The computer program of claim 18, wherein an image plane coordinate is identified with respect to a first direction substantially parallel to a projection onto the image plane of a beam axis of a radiation beam directed toward the target location, and the peripheral beam spot point is located at a peripheral area of the beam spot closer to the beam axis than other comparable peripheral areas of the beam spot.

20. The computer program of claim 18, wherein the at least one mage plane coordinate is identified by applying a threshold to pixel values of the beam spot image.
